(19) United States
(12) Patent Application Publication
(10) Pub. No.: US 2018/0017735 A1
(43) Pub. Date: Jan. 18, 2018

(54) Wavelength Division Multiplexer/Demultiplexer with Flexibility of Optical Adjustment

(71) Applicant: Futurewei Technologies, Inc., Plano, TX (US)

(72) Inventors: Rongsheng Miao, San Jose, CA (US); Yu Sheng Bai, Los Altos Hills, CA (US)

(21) Appl. No.: 15/598,518

(22) Filed: May 18, 2017

Related U.S. Application Data
(60) Provisional application No. 62/361,865, filed on Jul. 13, 2016.

(51) Int. Cl. G02B 6/293; G02B 6/34; G02B 6/32; G02B 6/42

(52) U.S. Cl. CPC G02B 6/29365; G02B 6/4255; G02B 6/425; G02B 6/2938; G02B 6/34; G02B 6/32; G02B 6/4214

(57) ABSTRACT

Multiplexer and demultiplexer apparatuses are disclosed herein. In various embodiments, a demultiplexer apparatus comprises a receptacle having a collimate lens and configured to receive an inlet light, a substrate, a reflector mounted to the substrate and configured to reflect the inlet light. The reflector is either fixed or adjustable during assembly. The demultiplexer apparatus also includes a demultiplexer block coupled to the substrate and configured to receive the inlet light from the reflector and separate the inlet light into multiple wavelengths, a folding prism coupled to the substrate that receives and refracts the multiple wavelengths through the substrate, and a focal lens array coupled to the substrate to receive the focus of the multiple wavelengths.

### CROSS-REFERENCE TO RELATED APPLICATIONS

This application is a non-provisional application of U.S. Provisional Application No. 62/361,865, filed on Jul. 13, 2016, entitled “Wavelength Division Multiplexer/Demultiplexer with Flexibility of Optical Adjustment,” which is hereby incorporated by reference in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A passive optical network (PON) is one system for providing network access over the last mile. A PON may be a point-to-multipoint (P2MP) network with passive splitters positioned in an optical distribution network (ODN) to enable a single feeding fiber from a central office to serve multiple customer premises. A PON may employ one wavelength for upstream traffic and another for downstream traffic on a single fiber. For example, the upstream traffic may be carried by a 1310 nanometer (nm) wavelength light and the downstream traffic may be carried by a 1490 nm wavelength light. As such, a PON transceiver may employ a transmitter optical sub-assembly (TOSA) package and a receiver optical sub-assembly (ROSA) package to couple an outgoing light emitted from a transmitter optically with a single fiber and also to couple an incoming light from the single fiber to a receiver.

Wavelength division multiplexers/demultiplexers are widely used in fiber optic TOSA/ROSA packages in both telecommunication and data center industries. In current markets, demand for small size and low cost modules, like Quad Small Form-Factor Pluggable 28 (QSFP28 and uQSFP28) packages, is increasing. This is especially true in the data center applications, which require miniaturization and low cost for the TOSA/ROSA packages. The typical multiplexer/demultiplexer (mux/demux) consists of multiple standalone components in the packaging, such as a fiber receptacle, a collimate lens, an optic mux/demux block, and a focal lens array. Integration of these components into a single piece monolithic component is a typical solution to reduce the size and cost. For example, the monolithic component may be made from UItem® plastic, which is widely used in optical packaging due to UItem® plastic having stable mechanical and thermal characteristics. An example of a prior art wavelength division mux/demux can be found in U.S. Pat. No. 6,201,908, which discloses a fiber optic fiber receptacle, a collimate lens, an internal reflector, as well as an aspheric lens molded in a single piece.

### SUMMARY

According to one aspect of the present disclosure, there is provided an optical wavelength division demultiplexer that includes a receptacle having a collimate lens and configured to receive an inlet light, a substrate, a reflector mounted to the substrate and configured to reflect the inlet light and separate the inlet light into multiple wavelengths, a demultiplexer block coupled to the substrate and configured to receive the inlet light from the reflector, a folding prism coupled to the substrate and configured to receive the multiple wavelengths from the demultiplexer block and refract the multiple wavelengths through the substrate, and a focal lens array coupled to the substrate substantially opposite the folding prism and configured to receive and focus the refracted multiple wavelengths.

Optionally, in any of the preceding aspects, another implementation of the aspect provides that the reflector is a fixed reflector or an adjustably-affixed reflector.

Optionally, in any of the preceding aspects, another implementation of the aspect provides that the reflector is either an external reflector or an internal reflector.

Optionally, in any of the preceding aspects, another implementation of the aspect provides that a surface of the reflector is coated with at least one of a high reflective coating or a metal layer.

Optionally, in any of the preceding aspects, another implementation of the aspect provides that the receptacle, the substrate, and the folding prism are part of a single molded piece, and that the reflector is separate from the single molded piece and bonded to the single molded piece after alignment.

Optionally, in any of the preceding aspects, another implementation of the aspect provides that the reflector is adjusted in both linear position and angular orientation before being affixed to the substrate to control an incident angle and an incident location of the inlet light reflected into the demultiplexer block.

Optionally, in any of the preceding aspects, another implementation of the aspect provides that an optical path of the inlet light is directed through the reflector and the demultiplexer block to the folding prism in a first plane, and the refracted multiple wavelengths exit the focal lens array in a direction substantially perpendicular to the first plane.

Further, according to one aspect of the present disclosure, there is provided a method that includes receiving, at a receptacle having a collimate lens, an inlet light, reflecting, by a reflector mounted to a substrate, the inlet light at an angle, receiving, by a demultiplexer block coupled to the substrate, the inlet light from the reflector, separating, by the demultiplexer block, the inlet light into multiple wavelengths, receiving, by a folding prism coupled to the substrate, the multiple wavelengths from the demultiplexer block, refracting, by the folding prism, the multiple wavelengths through the substrate, and focusing, by a focal lens array coupled to the substrate substantially opposite the folding prism, the refracted multiple wavelengths.

Optionally, in any of the preceding aspects, another implementation of the aspect provides that the reflector is a fixed reflector or an adjustably-affixed reflector.

Optionally, in any of the preceding aspects, another implementation of the aspect provides that the reflector is either an external reflector or an internal reflector.

Optionally, in any of the preceding aspects, another implementation of the aspect provides that a surface of the reflector is coated with at least one of a high reflective coating or a metal layer.

Optionally, in any of the preceding aspects, another implementation of the aspect provides that the receptacle, the substrate, and the folding prism are part of a single molded piece, and that the reflector is separate from the single molded piece and bonded to the single molded piece after alignment.

Optionally, in any of the preceding aspects, another implementation of the aspect provides that the reflector is adjusted in both linear position and angular orientation before being affixed to the substrate to control an incident angle and an incident location of the inlet light reflected into the demultiplexer block.

Optionally, in any of the preceding aspects, another implementation of the aspect provides that an optical path of the inlet light is directed through the reflector and the demultiplexer block to the folding prism in a first plane, and the refracted multiple wavelengths exit the focal lens array in a direction substantially perpendicular to the first plane.

Moreover, according to one aspect of the present disclosure, there is provided an optical wavelength division multiplexer that includes a substrate having a first side and a second side, a focal lens array coupled to the first side of the substrate and configured to receive and focus the multiple wavelengths intended for transmission, a folding prism coupled to the second side of the substrate substantially opposite the focal lens array and configured to receive the multiple wavelengths from the focal lens array and refract the multiple wavelengths through the substrate, a multiplexer block coupled to the second side of the substrate and configured to receive the multiple wavelengths from the folding prism, wherein the multiplexer block combines the multiple wavelengths into a combined beam, a reflector mounted to the second side of the substrate and configured to reflect the combined beam at an angle, and a receptacle having a collimate lens and configured to receive the combined beam from the reflector and transmit an outlet light.

Optionally, in any of the preceding aspects, another implementation of the aspect provides that the reflector is a fixed reflector or an adjustably-affixed reflector.

Optionally, in any of the preceding aspects, another implementation of the aspect provides that the reflector is either an external reflector or an internal reflector.

Optionally, in any of the preceding aspects, another implementation of the aspect provides that the receptacle, the substrate, and the folding prism are part of a single molded piece, and that the reflector is separate from the single molded piece and bonded to the single molded piece after alignment.

Optionally, in any of the preceding aspects, another implementation of the aspect provides that the reflector is adjusted in both linear position and angular orientation before being affixed to the substrate to control an incident angle and an incident location of the combined beam reflected into the receptacle.

Optionally, in any of the preceding aspects, another implementation of the aspect provides that the combined beam is directed from the folding prism through the multiplexer block and the reflector in an optical path in a first plane, and the multiple wavelengths intended for transmission enter the focal lens array in a direction substantially perpendicular to the first plane.

Any of the above embodiments may be combined with any of the other above embodiments to create a new embodiment. These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIGS. 1A, 1B, and 1C illustrate a multiview orthographic projection of a mux/demux apparatus in accordance with various embodiments of the disclosure;

FIGS. 2A and 2B illustrate a mux/demux apparatus having an internal reflector in accordance with various embodiments of the disclosure;

FIGS. 3A and 3B illustrate a mux/demux apparatus having an external reflector in accordance with various embodiments of the disclosure;

FIG. 4 illustrates an exemplary demultiplexing of multiple wavelengths in a demultiplexing block in accordance with various embodiments of the disclosure;

FIGS. 5A, 5B, and 5C illustrate a folding prism and an optical path inside the folding prism in accordance with various embodiments of the disclosure;

FIGS. 6A, 6B, and 6C illustrate a stepped folding prism and an optical path inside the stepped folding prism in accordance with various embodiments of the disclosure;

FIG. 7 illustrates a perspective view of a packaged demultiplexer in accordance with various embodiments of the disclosure;

FIG. 8 illustrates focal points offset from a centerline of a packaged demultiplexer in accordance with various embodiments of the disclosure; and

FIG. 9 illustrates a flowchart of an exemplary method of optical demultiplexing of multiple wavelengths.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The previously discussed monolithic optical package may have drawbacks in optimizing the optical performance and component layout due to manufacturing limitations. Since all the components are molded in a single piece, the mux/demux does not allow for any optical adjustment during assembly. Therefore, an incident angle into the mux/demux as well as the accuracy of the pitch and locations of optical focal points are pre-determined by the accuracy of the components as well as the accuracy of the bonding processes. This may result in both unfavorable optical performance and cost of assembly. As such, the present disclosure identifies a need for improved miniaturization, reduced cost, and optical performance in optical packages.

Disclosed herein is a mux/demux apparatus having a single molded component comprising a receptacle, a demultiplexer block, a folding prism, or a combination thereof, which can result in more accurate and cost effective multiplexer and demultiplexer apparatuses. The mux/demux apparatus also includes a reflector that can be either fixed or adjustably-affixed during assembly. A fixed reflector is part of a single piece molded apparatus. An adjustably-affixed reflector is bonded to the single molded component after the reflector is aligned and adjusted for optical performance during the assembly process. The adjustably-affixed reflector can be adjusted to control both the incident angle and the incident location with the demultiplexer block. Further, an optical path of the light beam, which defines a first plane, travels through the reflector and the demultiplexer to the folding prism, and exits the folding prism in a direction substantially perpendicular to the first plane, and light focal points are located off a centerline of the apparatus.

The various embodiments disclosed herein will be described as a demultiplexer, although the same embodiments can also be implemented as a multiplexer by reversing the optical path. The disclosed mux/demux can be used in high speed TOSA/ROSA applications. Further, the mux/demux may be advantageous due to the high integration of packaging of single molded components, and due to the flexible optical adjustment of the reflector.

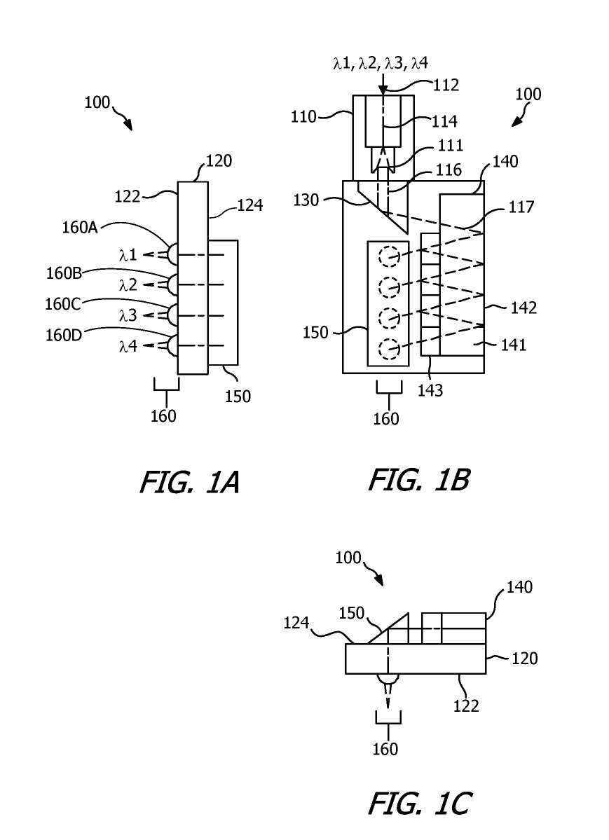

In accordance with various embodiments, FIGS. 1A, 1B, and 1C illustrate first side, top side, and second side projection views of an optical wavelength division demultiplexer 100. The optical wavelength division demultiplexer 100 comprises a receptacle 110 having a collimate lens 111 and configured to receive an inlet light 114; a substrate 120 having a first side 122 and a second side 124; a reflector 130 mounted to the second side 124 of the substrate 120 and configured to reflect the inlet light 114 at an angle; a demultiplexer block 140 coupled to the second side 124 of the substrate 120 and configured to receive the inlet light 114 from the reflector 130, wherein the demultiplexer block 140 separates the inlet light 114 into multiple wavelengths (λ1, λ2, λ3, and λ4); a folding prism 150 coupled to the second side 124 of the substrate 120 and configured to receive the multiple wavelengths from the demultiplexer block 140 and refract the multiple wavelengths; and a focal lens array 160 coupled to the first side 122 of the substrate 120 substantially opposite the folding prism 150 and configured to receive and focus the refracted multiple wavelengths. While four wavelengths (λ1, λ2, λ3, and λ4) are shown, more or fewer wavelengths are within the scope of this disclosure.

The receptacle 110 can support communication via an optical interface. Further, the inlet light 114 from a fiber 112 embedded in the receptacle 110, either single mode or multi-mode, becomes a collimated beam 116 through the collimate lens 111.

In various embodiments, the reflector 130 is mounted to the substrate 120 and configured to reflect a collimated beam 116, for example to reflect the collimated beam 116 at a substantially right angle. For example, the collimated beam 116 is reflected at 90° (degrees), within 85° to 95°, or within 80° to 100° from the direction of the collimated beam 116 exiting the reflector 130 relative to the direction entering the reflector 130. Reflector 130 reflects the collimated beam 116, as reflected beam 117, according to a total internal reflection, toward the demultiplexer block 140. In various embodiments, the reflector 130 is a fixed reflector and molded as part of the apparatus, as shown in FIG. 1. In other embodiments, the reflector 130 is adjustable and mounted to the substrate 120 after alignment during the assembly process.

In various embodiments, the demultiplexer block 140 is coupled to the substrate 120 and configured to receive the reflected beam 117 from the reflector 130. The demultiplexer block 140 comprises an optical block 141 having a reflective surface 142 and a plurality of filters 143 or filter regions. The reflective surface 142 is coated with a reflective layer to reflect the reflected beam 117. The reflective layer can be gold, aluminum, or similar metal, for example. The plurality of filters 143 is configured to filter the multiple wavelengths (λ1, λ2, λ3, and λ4) within the reflected beam 117. The reflected beam 117 is reflected in a zigzag pattern in the demultiplexer block 140 between the plurality of filters 143 and the reflective surface 142. As the reflected beam 117 enters each of the plurality of filters 143, one of n different multiple wavelengths (λ1, λ2, λ3, and λ4) of light is transmitted through each of the plurality of filters 143 and the separated multiple wavelengths (λ1, λ2, λ3, and λ4) move along the optical pathways toward the folding prism 150.

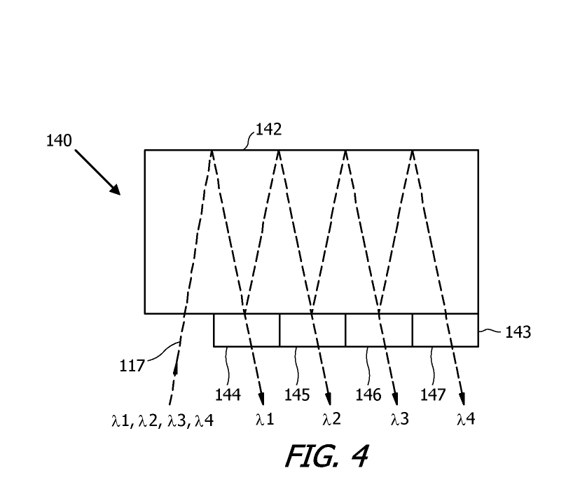

For example and with reference to FIG. 4, reflected beam 117 having multiple wavelengths (λ1, λ2, λ3, and λ4) enters the demultiplexer block 140 with an incident angle. The reflected beam 117 is reflected on the reflective surface 142, and reaches a first filter 144 of the plurality of filters 143. The first filter 144 is configured to substantially allow the first wavelength λ1 to pass through, and reflect the remaining wavelengths (λ2, λ3, and λ4) back to the reflective surface 142. The reflective surface 142 reflects the remaining wavelengths (λ2, λ3, and λ4) back to a second filter 145 of the plurality of filters 143. The second filter 145 of the plurality of filters 143 is configured to allow the second wavelength λ2 to substantially pass through, and reflect the remaining wavelengths (λ3 and λ4) back to the reflective surface 142. The process repeats at a third filter 146 and a fourth filter 147 of the plurality of filters 143 until the reflected beam 117 is demultiplexed into four individual wavelengths. Although the example is presented with four wavelengths, the optical wavelength division demultiplexer 100 can be configured to demultiplex any number of wavelengths.

In various embodiments, the demultiplexer block 140 can be formed from glass or molded plastic. However, it should be understood that other optical materials can be employed in forming the demultiplexer block 140. Further, the demultiplexer block 140 can also be bonded to the optical wavelength division demultiplexer 100 or can be formed as a portion of the optical wavelength division demultiplexer 100.

The folding prism 150 is coupled to the substrate 120 and configured to receive the filtered multiple wavelengths (λ1, λ2, λ3, and λ4) from the demultiplexer block 140 and refract the multiple wavelengths (λ1, λ2, λ3, and λ4). The multiple wavelengths (λ1, λ2, λ3, and λ4) traveling inside the folding prism 150 are refracted into a vertical or near vertical direction down towards the substrate 120, such as shown in FIGS. 1A and 1C. In various embodiments, the folding prism 150 is replaced by a folding mirror, which operates in the same or similar function as the folding prism 150.

The focal lens array 160 comprises focal lenses 160A-D coupled to the substrate 120 opposite the folding prism 150 and configured to receive and focus the refracted multiple wavelengths (λ1, λ2, λ3, and λ4). Although shown with four focal lenses 160A-D, the focal lens array 160 can be configured for any number of wavelengths. The multiple wavelengths (λ1, λ2, λ3, and λ4) of light refracted through the folding prism 150 are focused when passing through each of the focal lenses 160A-D and reach a corresponding photodiode (not shown). The focal lens array 160 can be injection molded to the substrate 120. The lenses of each of the focal lenses 106A-D of the focal lens array 160 can be a ball lens or aspheric lens, and the pitch of the focal lens array 160 is about the same as the pitch of a demultiplexer block, such as demultiplexer block 140. Additionally, the surface of the focal lenses 160A-D can be coated with an anti-reflective layer to reduce back reflection. The anti-reflective layer can comprise multiple layers of materials with different refractive indices.

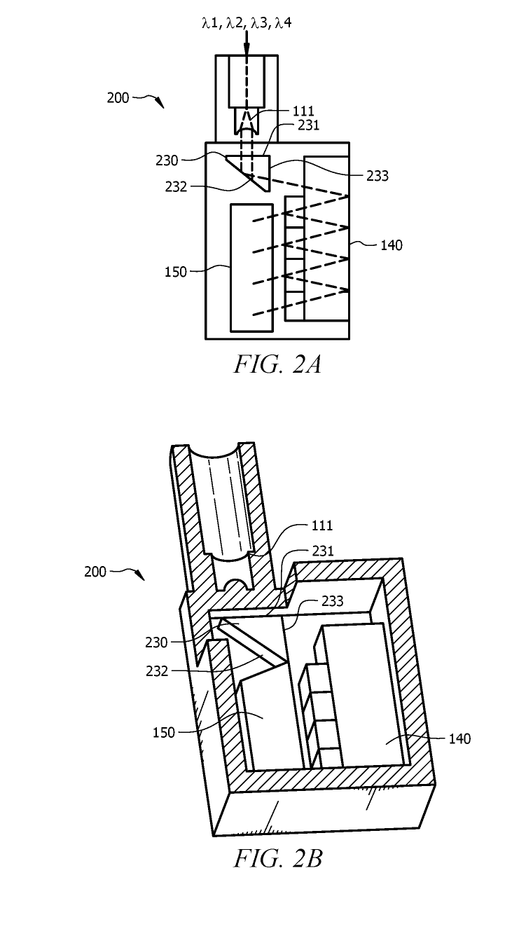

In various embodiments, the reflector 130 can be an internal reflector. FIGS. 2A and 2B illustrate an optical wavelength division demultiplexer 200 similar to the optical wavelength division demultiplexer 100. The optical wavelength division demultiplexer 200 comprises an internal reflector 230 and the demultiplexer block 140. An input beam passes through the internal reflector 230 on a first side 231, reflects off an interior wall 232 of the internal reflector 230, and the reflected beam passes through a third side 233 to the demultiplexer block 140. An incident angle between the initial beam and the exiting beam can be adjusted by rotating the internal reflector 230.

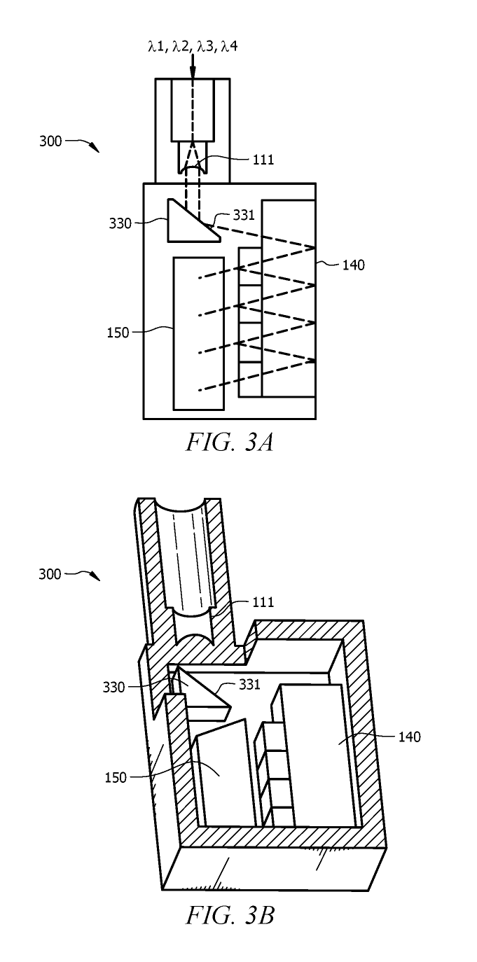

Similarly, in various embodiments, the reflector 130 can be an external reflector. FIGS. 3A and 3B illustrate an optical wavelength division demultiplexer 300 similar to the optical wavelength division demultiplexer 100. The optical wavelength division demultiplexer 300 comprises an external reflector 330 and a demultiplexer block 140. An input beam reflects off the exterior of a side 331 of the external reflector 330 to the demultiplexer block 140. The beam does not pass through the external reflector 330 in this embodiment. Instead, the reflective surface of the side 331 of the external reflector 330 is coated with at least one of a high reflective coating or a metal layer to facilitate reflection of the input beam.

The internal reflector 230 shown in FIGS. 2A and 2B, or the external reflector 330 shown in FIGS. 3A and 3B are adjustably-affixed reflectors that are separate and stand alone from a collimate lens, such as collimate lens 111, and are thus adjustable during the formation of the optical wavelength division demultiplexer 100. The external reflector 330 can be adjusted since the external reflector 330 is accessible during the assembly process. Both the linear position and the angular orientation can be precisely adjusted to control the incident angle and the incident location into the demultiplexer block 140. The angular orientation can be adjusted by adjusting an angle of the reflective surface relative to the collimate lens 111. The linear position of the external reflector 330 can be adjusted by moving the position of the external reflector 330 to be closer to or farther away from the collimate lens 111. The incident angle has an effect on a center wavelength of each channel as well as the pitch of the focal points. After the adjustment is completed, the adjustably-affixed external reflector 330 is bonded in place using adhesives or the like.

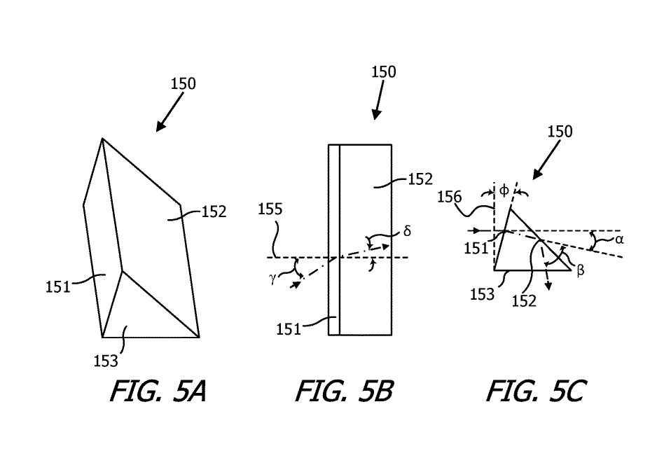

FIGS. 5A, 5B, and 5C illustrate the folding prism 150 and an optical path inside the folding prism 150 in accordance with various embodiments of the disclosure. FIG. 5A is a perspective view of the folding prism 150, FIG. 5B is a top view, and FIG. 5C is an end view. The folding prism 150 has a first surface 151, a second surface 152, and a third surface 153. The first surface 151 is disposed at an angle φ with respect to vertical 156, as shown in FIG. 5C. Incoming light impinges on the folding prism 150 at an incident angle γ with respect to the first surface 151, as shown in FIG. 5B, with the light arriving from the demultiplexer block (not shown), such as the demultiplexer block 140 of FIG. 4. The folding prism 150 refracts the incoming light by a third angle δ due to the incident angle γ of the light to the first surface 151. The light is refracted in the horizontal plane 155 in FIG. 5B, at the third angle δ, by the first surface 151. The folding prism 150 also refracts the light at a first angle α at the first surface 151 due to the angle φ of the first surface 151, wherein the entering light is refracted a few degrees downward in FIG. 5C. The magnitude of the first angle α depends on a refraction index of the material of the folding prism 150 and any coatings, as well as the angles within the folding prism 150. The light is reflected down farther at the second surface 152 by a second angle β due to total internal reflection. The light then travels downwards through the third surface 153 into a focal lens array (not shown), such as the focal lens array 160 of FIG. 1. The light travels substantially perpendicular to the third surface 153 in some embodiments as the light exits the folding prism 150.

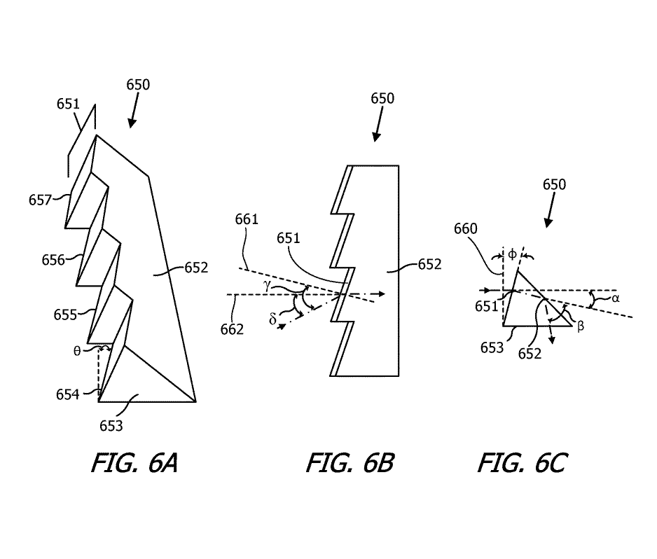

In various embodiments and with reference to FIGS. 6A, 6B, and 6C, the folding prism 150 can be a stepped folding prism 650 having a stepped surface 651, a second surface 652, and a third surface 653. FIG. 6A is a perspective view of the stepped folding prism 650, FIG. 6B is a top view, and FIG. 6C is an end view simplified by omitting the stepped features of the stepped surface 651. The stepped folding prism 650 includes light-receiving faces 654, 655, 656, 657 that together form the stepped surface 651. Each light-receiving face 654, 655, 656, 657 has a surface at a same step angle θ, as shown in FIG. 6A. The light-receiving faces 654, 655, 656, 657 are further disposed at an angle φ with respect to vertical 660, as shown in FIG. 6C. Incoming light impinges on the stepped folding prism 650 at an incident angle γ with respect to a line 661 perpendicular to the stepped surface 651, as shown in FIG. 6B, with the light arriving from the demultiplexer block (not shown), such as the demultiplexer block 140 of FIG. 4. The stepped folding prism 650 refracts the incoming light by a third angle δ due to the angle θ of the stepped surface 651 and the incident angle γ of the impinging light. The third angle δ in FIGS. 6A-6C may be different from the third angle δ in FIGS. 5A-5C. The light is refracted in the horizontal plane 662 in FIG. 6B at the third angle δ by a face of the stepped surface 651. The stepped folding prism 650 also refracts the light at a first angle α at the stepped surface 651 due to the angle φ of the stepped surface 651, wherein the entering light is refracted a few degrees downward in FIG. 6C. The light is reflected farther down at the second surface 652, at a second angle β, due to total internal reflection. The light then travels downwards through the third surface 653, exiting into a focal lens array (not shown), such as the focal lens array 160 of FIG. 1. The light travels substantially perpendicular to the third surface 653 in some embodiments as the light exits the stepped folding prism 650.

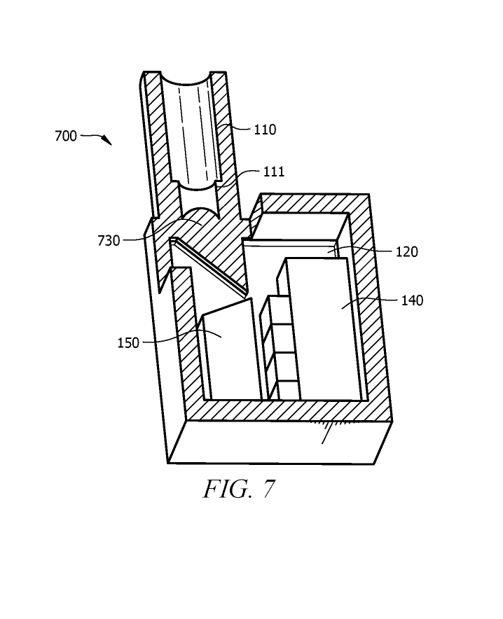

FIG. 7 shows a sectional view of a single molded piece demultiplexer 700 formed using injection molding. In various embodiments, a receptacle 110, a collimate lens 111, and a substrate 120 are part of the single molded piece demultiplexer 700. For example, single molded piece demultiplexer 700 can be made from UItem® polyetherimide (PEI) manufactured by GE Plastics. UItem® PEI has higher thermal and chemical stability than other similar plastics. In addition, UItem® PEI can include an anti-reflective coating at the surface where light beams pass in order to reduce back-reflection. In various embodiments, the single molded piece demultiplexer 700 can further comprise a reflector 730 formed as part of the single molded piece, such as reflector 130 of FIGS. 1A-C, a demultiplexer block 140, a folding prism 150, or any combination thereof. In other embodiments, the reflector 730 is separate from the single molded piece demultiplexer 700 and bonded to the single molded piece demultiplexer 700 after alignment so as to be adjustably-affixed, such as internal and external reflectors 230 and 330 of FIGS. 2A-B and 3A-B, respectively, in both linear position and angular orientation to control the incident angle and incident location into the demultiplexer block 140. The reflector 730 and the folding prism 150 can also be made of UItem® PEI, and can include anti-reflective coatings.

As illustrated in FIG. 7, the reflector 730, the demultiplexer block 140, and the folding prism 150 are positioned in or parallel to a first plane, wherein the optical path is directed through the reflector 730, the demultiplexer block 140, and to the folding prism 150, substantially parallel to and/or coplanar with the first plane. The optical path of the light beam traveling through the reflector 730 and the demultiplexer block 140 to the folding prism 150 defines the first plane or is substantially parallel to and/or coplanar with the first plane. The refracted multiple wavelengths exit the folding prism 150 in a direction perpendicular, or substantially perpendicular, to the first plane, and orthogonal to the substrate 120 (and therefore orthogonal to the first plane). For example, the refracted multiple wavelengths, such as wavelengths (λ1, λ2, λ3, and λ4), exit the folding prism 150 at 90°, within 85° to 95°, or within 80° to 100° from the direction of the refracted multiple wavelengths exiting the folding prism 150 relative to the first plane.

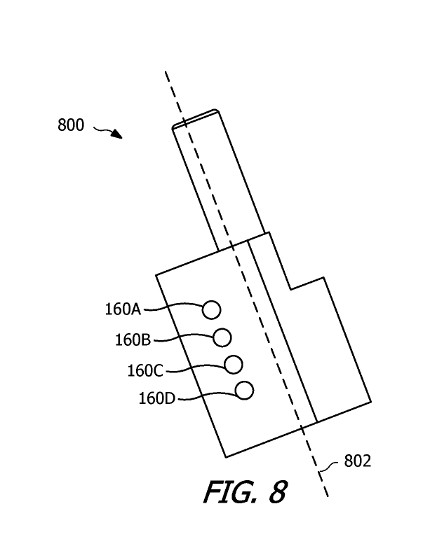

In accordance with various embodiments, the demultiplexer package, such as optical wavelength division multiplexer 100, is designed such that an optical path through the demultiplexer block 140 is substantially parallel to the substrate 120. In addition, the light focal points of the focal lens array 160 are positioned off a centerline of the demultiplexer package in some embodiments. For example, FIG. 8 illustrates focal lenses 160A-D offset from a centerline 802 of a demultiplexer package 800. This offset creates more space for layout of other electronic components. For example, the offset of the focal lenses 160A-D creates more space for radio frequency (RF) trace to fanout.

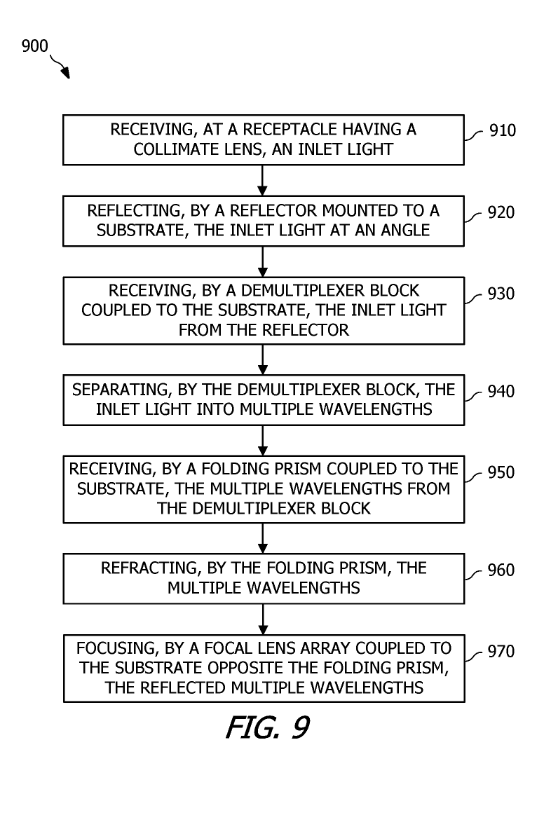

FIG. 9 is a flowchart of a method 900 of optical demultiplexing of multiple wavelengths according to an embodiment. With reference to FIG. 9, the exemplary method 900 of optical demultiplexing comprises the steps of receiving, at a receptacle having a collimate lens, an inlet light 910; reflecting, by a reflector mounted to a substrate, the inlet light at an angle 920; receiving, by a demultiplexer block coupled to the substrate, the inlet light from the reflector 930; separating, by the demultiplexer block, the inlet light into multiple wavelengths 940; receiving, by a folding prism coupled to the substrate, the multiple wavelengths from the demultiplexer block 950; refracting, by the folding prism, the multiple wavelengths 960; and focusing, by a focal lens array coupled to the substrate opposite the folding prism, the refracted multiple wavelengths 970.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether optically, mechanically, or otherwise. Other examples of changes, substitutions, and alterations are ascertainable by one skilled in the art and may be made without departing from the spirit and scope disclosed herein.

Although the present disclosure has been described with reference to specific features and embodiments thereof, it is evident that various modifications and combinations can be made thereto without departing from scope of the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

What is claimed is:

1. An optical wavelength division demultiplexer, comprising:
a receptacle having a collimate lens and configured to receive an inlet light;
a substrate;
a reflector mounted to the substrate and configured to reflect the inlet light;
a demultiplexer block coupled to the substrate and configured to receive the inlet light from the reflector, wherein the demultiplexer block separates the inlet light into multiple wavelengths;
a folding prism coupled to the substrate and configured to receive the multiple wavelengths from the demultiplexer block and refract the multiple wavelengths through the substrate; and
a focal lens array coupled to the substrate substantially opposite the folding prism and configured to receive and focus the refracted multiple wavelengths.

2. The optical wavelength division demultiplexer of claim 1, wherein the reflector is a fixed reflector or an adjustably-affixed reflector.

3. The optical wavelength division demultiplexer of claim 1, wherein the reflector is either an external reflector or an internal reflector.

4. The optical wavelength division demultiplexer of claim 3, wherein a surface of the reflector is coated with at least one of a high reflective coating or a metal layer.

5. The optical wavelength division demultiplexer of claim 1, wherein the receptacle, the substrate, and the folding prism are part of a single molded piece, and wherein the reflector is separate from the single molded piece and bonded to the single molded piece after alignment.

6. The optical wavelength division demultiplexer of claim 5, wherein the reflector is adjusted in both linear position and angular orientation before being affixed to the substrate to control an incident angle and an incident location of the inlet light reflected into the demultiplexer block.

7. The optical wavelength division demultiplexer of claim 1, wherein an optical path of the inlet light is directed through the reflector and the demultiplexer block to the folding prism in a first plane, and wherein the refracted multiple wavelengths exit the focal lens array in a direction substantially perpendicular to the first plane.

8. A method of optical wavelength division demultiplexing, comprising:
receiving, at a receptacle having a collimate lens, an inlet light;
reflecting, by a reflector mounted to a substrate, the inlet light at an angle;
receiving, by a demultiplexer block coupled to the substrate, the inlet light from the reflector;
separating, by the demultiplexer block, the inlet light into multiple wavelengths;
receiving, by a folding prism coupled to the substrate, the multiple wavelengths from the demultiplexer block;
refracting, by the folding prism, the multiple wavelengths through the substrate; and
focusing, by a focal lens array coupled to the substrate substantially opposite the folding prism, the refracted multiple wavelengths.

9. The method of claim 8, wherein the reflector is a fixed reflector or an adjustably-affixed reflector.

10. The method of claim 8, wherein the reflector is either an external reflector or an internal reflector.

11. The method of claim 10, wherein a surface of the reflector is coated with at least one of a high reflective coating or a metal layer.

12. The method of claim 8, wherein the receptacle, the substrate, and the folding prism are part of a single molded piece, and wherein the reflector is separate from the single molded piece and bonded to the single molded piece after alignment.

13. The method of claim 12, wherein the reflector is adjusted in both linear position and angular orientation before being affixed to the substrate to control an incident angle and an incident location of the inlet light reflected into the demultiplexer block.

14. The method of claim 8, wherein an optical path of the inlet light is directed through the reflector and the demultiplexer block to the folding prism in a first plane, and wherein the refracted multiple wavelengths exit the focal lens array in a direction substantially perpendicular to the first plane.

15. An optical wavelength division multiplexer, comprising:
a substrate having a first side and a second side;
a focal lens array coupled to the first side of the substrate and configured to receive and focus the multiple wavelengths intended for transmission;
a folding prism coupled to the second side of the substrate substantially opposite the focal lens array and configured to receive the multiple wavelengths from the focal lens array and refract the multiple wavelengths through the substrate;
a multiplexer block coupled to the second side of the substrate and configured to receive the multiple wavelengths from the folding prism, wherein the multiplexer block combines the multiple wavelengths into a combined beam;
a reflector mounted to the second side of the substrate and configured to reflect the combined beam at an angle; and
a receptacle having a collimate lens and configured to receive the combined beam from the reflector and transmit an outlet light.

16. The optical wavelength division multiplexer of claim 15, wherein the reflector is a fixed reflector or an adjustably-affixed reflector.

17. The optical wavelength division multiplexer of claim 15, wherein the reflector is either an external reflector or an internal reflector.

18. The optical wavelength division multiplexer of claim 15, wherein the receptacle, the substrate, and the folding prism are part of a single molded piece, and wherein the reflector is separate from the single molded piece and bonded to the single molded piece after alignment.

19. The optical wavelength division multiplexer of claim 18, wherein the reflector is adjusted in both linear position and angular orientation before being affixed to the substrate to control an incident angle and an incident location of the combined beam reflected into the receptacle.

20. The optical wavelength division multiplexer of claim 15, wherein the combined beam is directed from the folding prism through the multiplexer block and the reflector in an optical path in a first plane, and wherein the multiple wavelengths intended for transmission enter the focal lens array in a direction substantially perpendicular to the first plane.
